(19) United States
(12) Patent Application Publication
(10) Pub. No.: US 2003/0234892 A1
(43) Pub. Date: Dec. 25, 2003

(54) Television receiver with reduced flicker by 3/2 times standard sync

(76) Inventors: Julian Jaw-Long Hu, Sunnyvale, CA (US); Laurin Michael Pestes, Milpitas, CA (US)

Correspondence Address: Hung Chang LIN, 8 Schindler Court, Silver Spring, MD, 20903, US

(21) Appl. No.: 10/178,186

(22) Filed: Jun. 25, 2002

(51) Int. Cl. H04N 5/21

(52) U.S. Cl. 348/607; 348/910

(57) ABSTRACT

The horizontal synchronization frequency and the vertical synchronization frequency of a television receiver is increased by 3/2 times, so that refresh rate increased 3/2 times. The flicker of the displayed picture is thus reduced.

### BACKGROUND OF THE INVENTION

1. Field of the Invention

This invention relates to television receiver, particularly to the horizontal and vertical scanning system of the television receiver.

2. Brief Description of the Related Art

The problem of annoying display flickering on television due to the low frame scan rate (50 Hz-60 Hz) has been discussed for many years, especially for the viewers at the countries using 50 Hz PAL television system. The viewers are suffering the flickering ill effect on their eyes. The television system with a 60 Hz frame scan rate is somewhat better, although increasing of TV resolution and richer media content still cause the noticeable flickering, which poses as the major issue of TV consumers. There are modern techniques proposed to enhance the display quality, such as the HDTV (High Definition Television), which is driven by both government and industrial leaders as a new standard, but the progress is slow due to the immature infrastructure, the lack of program content, the unaffordable price for consumers, the unsettled standard of modulation, etc.

Another proposal is to double vertical refresh rate or progressive scan, such as the “100i” system (100 Hz Interlaced) system or the “60p” (60 Hz Progressive) system, which requires the changes in new architecture with several costly components, includes CRT (Cathode Ray Tube) and other control circuits. The result is not widely acceptable to consumers due to its high price.

### SUMMARY OF THE INVENTION

An object of the present invention is to reduce the flicker of television pictures. Another object of this invention is to reduce the flicker of a television picture using the conventional television transmission standards such as NTSC, PAL and SECAM. Still another object of this invention is to reduce the flicker of a television picture without incurring expensive cost.

These objects are achieved by increasing the frame refresh rate of the television picture. This is implemented by increasing the horizontal scan frequency and the vertical scan frequency such that the flicker is reduced. This is accomplished by shortening the dwell time of each picture element (pixel) on each horizontal line, and the time of each field of a frame.

Due to the need for reducing display flickering of TV, the new design multiplies 3/2 times the frequencies of standard TV sync, generating the vertical scan rate of 74.941 Hz for PAL system or 89.216 Hz for NTSC system. These frequencies turn out to be the best balance between flicker and cost.

With the 3/2 times frequency, the rest of sync processing is similar to standard TV. The Cathode Ray Tube (CRT) can also use the existing popular standard TV CRT, with the horizontal scan frequency at about 23.5 K Hz±1%. The TV board circuit design need not be switched among NTSC, PAL and SECAM for horizontal deflection circuit. The cost remains about the same as that for the present day TV horizontal deflection circuit. A unique advantage of this invention is the suitability for all sizes of TV receivers, such as he most popular household 25″ to 36″ TV sizes. These TV sets usually are not provided with HDTV, because HDTV requires bigger screen to appreciate the detail of high resolution display.

The same architecture can also extend to support high definition TV resolution, although the entire system cost will be increased significantly due to the high frequency of sync and high resolution with progressive scan.

### BRIEF DESCRIPTION OF THE DRAWINGS

FIG. 1 shows the block diagram of a conventional television receiver.

FIG. 2 shows the basic flow diagram of changing the horizontal scan frequency.

FIG. 3 shows the timing diagram of the horizontal sync signal and vertical sync signals: FIG. 3A, Timing Diagram of NTSC or PAL(M); FIG. 3B, Timing Diagram of PAL(I,B,G,H,D,N) or SECAM

FIG. 4 shows the block diagram of the television receiver based on the present invention.

FIG. 5 shows the application of a video processing chip incorporating the present invention for general use in a television set.

FIG. 6 shows the block diagram of the video processing chip.

### DETAILED DESCRIPTION OF THE PRESENT INVENTION

This section will describe the present invention to greatly reduce the display flickering on today's television screen while matching the similar hardware configuration of today's standard TV set with affordable price for consumers, and compatible to existing TV broadcasting standard.

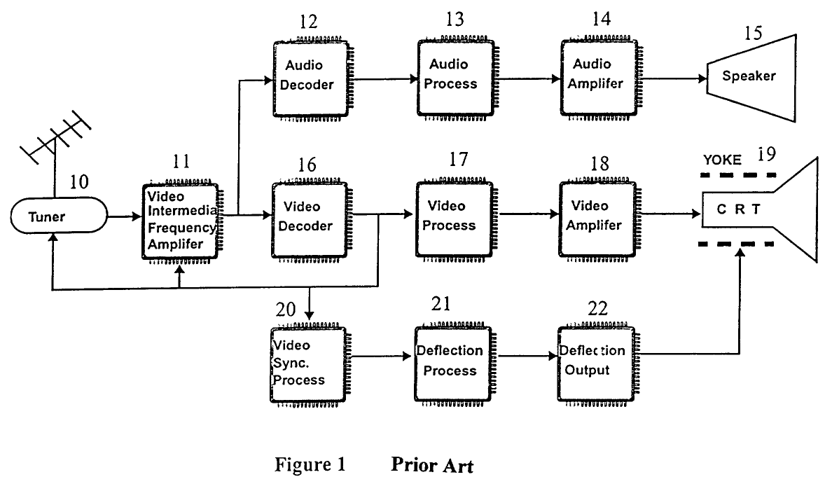

The present day TV set block diagram as illustrated in FIG. 1 comprises a tuner 10, an intermediate amplifier 11, an audio decoder 12 to demodulate the FM audio signal, an audio processor 13 to process the demodulated signal, an audio amplifier 14 to amplify the audio signal to drive a speaker 15. The video comprises a video decoder 16 to convert the AM video signal into digital data for each pixel on a scan line and to generate the horizontal sync frequency Fh and the vertical sync frequency Fv, which follows the standard of NTSC, PAL & SECAM standards to generate an interlaced video signal with 525 or 625 lines per picture frame at a respective 50 or 60 Hz picture rate. The digital data are then processed in the video processor 17 and converted back to an analog signal, which is amplified by the video amplifier 18 for driving the cathode ray tube 19. The sync signals are segregated out from the video decoder 16 to feed a video sync processor 20, which the deflection yokes of the CRT 10 through a deflection output stage 22. Each picture frame has two fields at one half the frame rate, which create the flicker problem.

The principle of the present invention is to effectively increase the horizontal scan frequency and the vertical scan frequency. When the scan rates are increased, the picture appears more persistent and the flicker due to slow vertical scan is reduced.

In this invention, the scan rate is increased by increasing the horizontal scan frequency and the vertical scan frequency. A horizontal line consists of a large number of pixels. By shortening the dwell time each pixel, the scan time of a horizontal line is reduced, i.e. the horizontal scan frequency is increased. Similarly, the vertical field consists of a large number of lines (e.g. 252.5 lines per field for NTSC system). By shortening the scan time of each horizontal line, the time of each vertical field is reduced. When the increasing the vertical scan frequency by 3/2 times, the normal time of a vertical field is reduced. Since flickering is due to the slow scan rates bordering the sensitivity threshold of human eyes, increasing the number of frame rate can greatly reduce the flicker as seen by human eyes.

In the present invention, the incoming signals are the standard NTSC, PAL or SECAM signals with the following specifications of horizontal sync frequency Fh, and vertical sync frequency Fv:

NTSC: Fh=15,734 KHz, Fv=59.94 Hz

PAL (I, B, G, H, D, N): Fh=15.625 KHz, Fv=50.00 Hz

SECAM: Fh=15.625 KHz; Fv=50.00 Hz

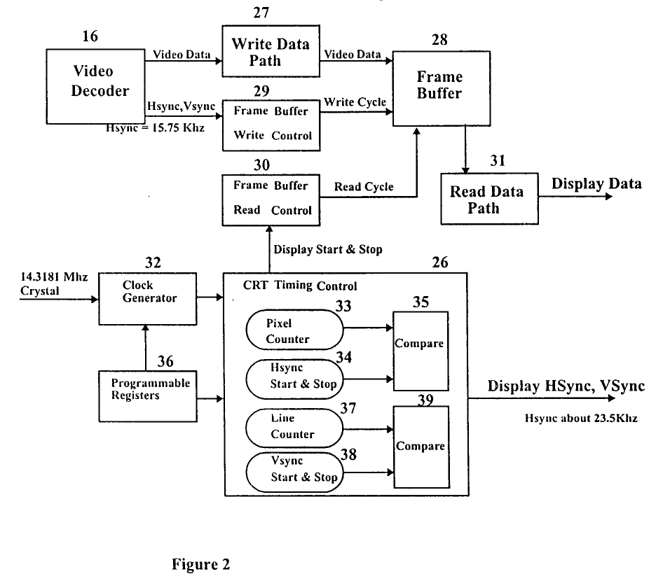

This invention is to increase the horizontal sync frequency and the vertical frequency by one and a half times. FIG. 2 shows the block diagram to implement the change. The audio signal which lies in a separate frequency spectrum, is separated out and processed differently.

The scan rate conversion is needed in order to enable a decoupling of the received video format and the display format. The number of output video scan lines and the pixel clock frequency are designed to be programmable inside the frame based video processor.

The new Fh and Fv are generated as follows:

NTSC: Fh=23.601 K Hz, Fv=89.91 Hz

PAL(I,B,G,H,D,N): Fh=23.4375 K Hz, Fv=75.00 Hz

PAL(M): Fh=23.601 K Hz, Fv=89.91 Hz

SECAM: Fh=23.4375 K Hz, Fv=75.00 Hz

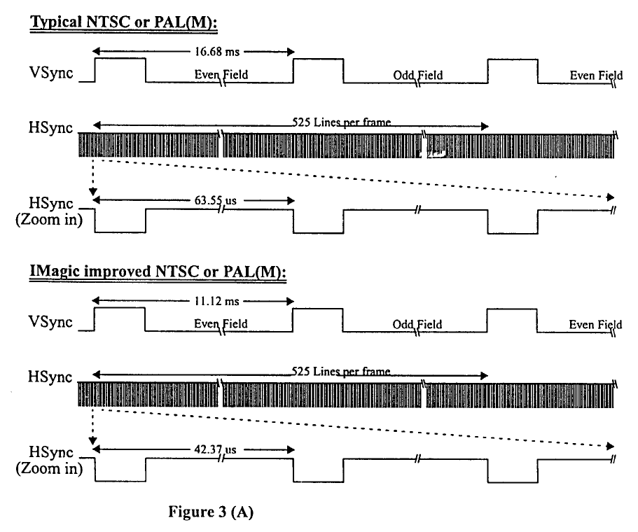

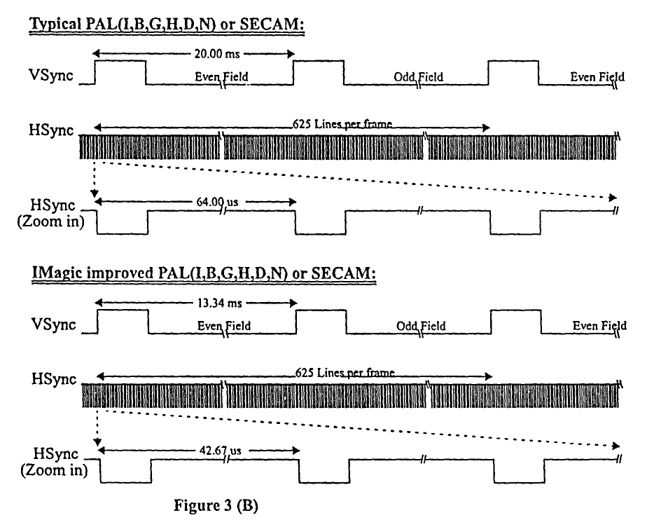

The scheme for implementing the change of the sync frequencies is shown in FIG. 3. The video decoder 16 converts the analog video signal into digital data by means of A/D conversion technique. The digital video data corresponding to each pixel on a horizontal line are written through data path 27 into Frame Buffer 28, which includes a memory such as a shift register to hold the video digital data at a first clock rate, the de-interlacing implementation is applied here. Then the digital data stored in the Frame Buffer 28 are then read out at a faster clock rate, which are then converted into analog video signal in the Read Data block 31 for driving the cathode ray tube. Thus the scan time of a horizontal line becomes shorter than the incoming signal. The incoming horizontal sync signal controls the time to retrace the next line is written into the Frame Buffer, but converted to a new sync signal faster than the incoming sync signal. In a similar manner, the incoming vertical sync signal which controls the retrace time each vertical field is also converted into a faster sync signal in the Frame Buffer.

The clock for reading the data in the Frame Buffer memory is derived from a clock generator 32. It is a frequency synthesizer, which uses a crystal as a reference frequency and a phase locked loop to derive the different new clock and sync frequencies. The output frequencies of the frequency synthesizer are controlled by Programmable Registers 36, which determines the frequency division of the voltage controlled oscillator in the frequency synthesizer for deriving the new frequencies for the NTSC, PAL or SECAM systems. The signal from the clock generator 32 is fed to a CRT Timing control block, which feeds the clock frequencies for the Frame Buffer through a Frame Buffer Read Control block 26; and generates the new Display horizontal sync at 23.601 kHz (for NTSC signals) and the new vertical sync frequency at 89.91 Hz (for NTSC signals). The Hsync signal is derived by a pixel counter 33, which counts the number of pixels on each line to compare with a predetermined Fh count in the compare block 35 to control retracing and restarting of a horizontal scan in the Hsync Start & Stop block 34. Similarly, the Vsync signal is derived from the Line counter 37 which counts the number of lines on each vertical field to compare with predetermined Fv count in the compare block 39 to control retracing and restarting of a vertical field in Vsync Start & Stop block 38. The timing diagrams of the new sync signals as compared with the conventional sync signals are shown in FIG. 3A for NTSC standard and FIG. 3B for PAL standard.

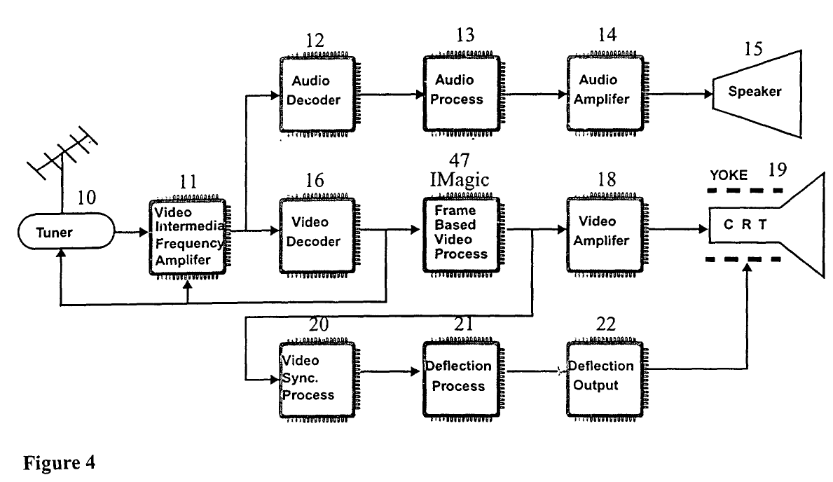

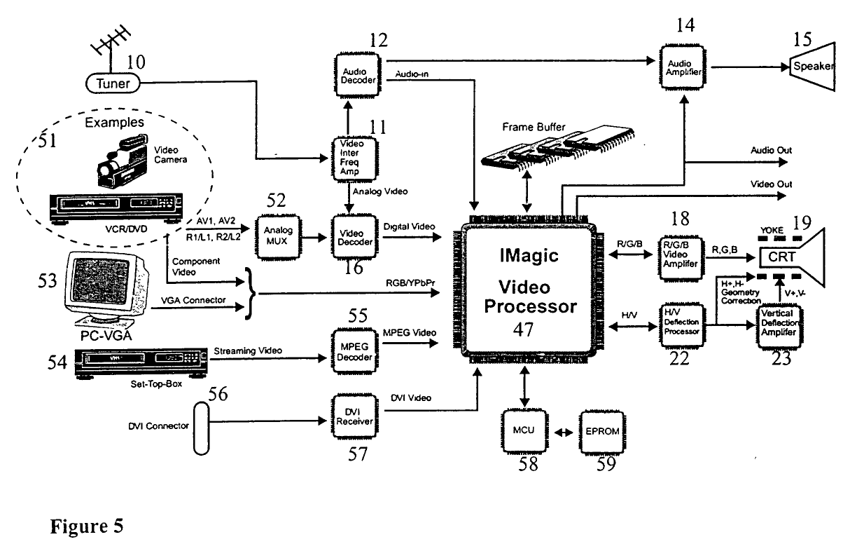

The basic scheme for increasing the Hsync and the Vsync of a television receiver is incorporated in a Frame Based Video Processor block “IMagic” as a block of a television receiver shown in FIG. 4. The IMagic block also incorporates other features of a modem television receiver as shown in FIG. 5, which includes inputs for video camera, VCR, PC-VGA, MPEG video, DVI video. In all these auxiliary applications, the input signals adopt conventional formats such as NTSC, PAL or SECAM, and are processed the same manner as the basic scheme described in FIG. 2. The complete “IMagic” block diagram is shown in FIG. 5. The block is a frame based video processor to generate customized about 23.5 K Hz Fh to the sync processor and the corresponding Fv for NTSC, PAL and SECAM. The change is to replace the video processor in the conventional television receiver shown in FIG. 1 with the frame based video processor which separates out the sync signals.

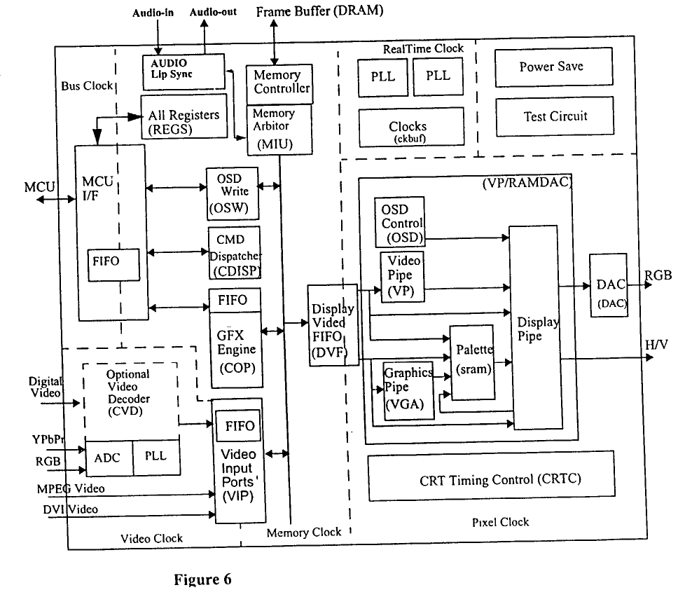

The frame based video processor is a SOC (System-On-Chip) using advanced CMOS mixed signal technology, it combines the interlaced to progressive scan and back to interlaced conversion, programmable scaling, CRT timing generation and many other video processing techniques. The feature of the invention is the 3/2 times sync frequency. The chip size is estimated about 25 (mm)2 using CMOS 0.25 um technology, it requires the frame buffer of 4, 8 or 16M Byte. FIG. 6 shows the functional block diagram of the chip (IMagic), Functional Block Descriptions of the IMagic chip are as follows:

1. MCU I/F (MCUIF): The MCU (Micro Controller) Interface provides the means for the external low cost CPU & its firmware to communicate with the chip for the purposes of setting up configuration registers, enabling functions, enabling the varieties of video streams writing to frame buffer through the memory arbitor, etc. It contains the on screen display control and the I2C serial bus.

2. Registers from all (REGS): The registers resides in all required blocks, it contains the configuration and control registers. These registers may be accessed via the I2C bus using MCU. The purpose is to separate all registers in each block, to optimize the physical floor plan and to avoid the routing congestion compared to only one central register block.

3. Video Input Port (VIP): The Video Input Port provides an interface to various digitizers and decoders, as well as a integrated Video Decoder option. The video streams includes 2 ports of video decoder outputs, digital RGB, YCbCr, YPbPr and the output of DVI receiver. It contains bus width translations for video to frame buffer memory write.

4. Video Decoder(CVD): The integrated video decoder is preferable to take external tuner output of composite or s-video signals and generate the digital YUV signals for internal video input port. The video decoder prefers to contain the digital 3D comb filter and Closed caption stream decoder.

5. ADC: The ADC will have 2 sets so that IMagic can support the PIP or POP among video input sources, at least 1 set of high speed ADC being required to handle either video decoder or PbPr/RGB.

6. Memory Controller (MIU): The memory controller provides prioritized access to the frame buffer memory. Memory arbitration are done by fixing priority, combined with programmable cycle length. Refresh cycle are provided by internal 512 clocks counter or blanking period.

7. OSD Write (OSW): The OSW block contains the on screen display control data written into display memory. The OSD data can be text-based or bit-mapped (graphics) based. Writing the OSD data into memory allows the stretch/scaling of OSD images.

8. GFX Engine: This block provides 64-bit 2D acceleration for graphics. It contains the Bit Block Transfer and line draw engine, etc. It can execute one operation in every clock cycle. IMagic preserves this block for the usage of Interactive TV or the Electronic Programming Guide scrolling function.

9. OSD Control: The hardware OSD control block handles memory read accesses for the OSD image, and does the Blinking, Transparency and Blending.

10. Display/Video FIFO: The overlay FIFO block handles memory read accesses for video overlays, to contain the video streams for OSD, Picture in Picture(PIP), or Split Screen(POP). The frame rate conversion and de-interlacing functions also require the read access to the frame buffer.

11. Graphics Pipe: This block contains the Graphics or VGA compatibility logic for the pixel path. It includes VGA attribute control and allows the switch of digital RGB stream overlay with OSD and PIP.

12. Palette: This block contains 2 sets of SRAM, one used for the Gamma control of display output, the other used to store the bit-mapped OSD image.

13. Video Pipe: The video pipe performs the video acceleration, control and blending functions. These functions are: video window set up for PIP, POP, color space conversion, both X and Y image scaling 4:3, 16:9, panorama, zoom, De-Interlacing, Frame-Rate Conversion. Video 1 & Video 2 FIFO are used to stored current and proceeding line video data for Vertical interpolation.

14. Display Pipeline: This block merges the primary video display, the overlay(s) and the OSD. The advanced picture processing is done at this block including Luminance/Chrominance Transience, Gamma Control, Black Level Adjustment, Brightness/Contrast adjustment, White Level fine tune, hue, saturation level, and the overlay pictures blending, etc.

15. CRT Control (CRTC): The CRTC block controls the synchronization signals for the displays, as well as overlay and OSD positioning.

16. AUDIO Lip Sync (ALS): This block contains the synchronization circuit for audio signals to align the pipe line stages required to output video stream.

17. DAC: This block contains the digital analog converters for RGB monitors. It can run up to 170 Mhz with 3.3V operation.

18. PLL: This block contains the phase lock loops for memory and pixel clock generation.

19. Clocks: This block contains the clock enables, MUXes and buffers for the memory, pixel, bus and video port clocks.

20. Power Management: This block contains control for the various power management features.

21. Test Circuit:This block contains test circuit for both standard cell logic and line buffer/SRAM logic.

While the preferred embodiments of the invention have been described, it will apparent to those skilled in the art that various modifications can be made without departing from the spirit of this invention. Such modifications are all within the scope of this invention.

1. A television (TV) receiver for receiving conventional TV signals selected from a group consisting of NTSC, PAL and SECAM standards, comprising:
circuits for processing an incoming composite signal having an AM video signal for displaying a picture on a cathode ray tube, an FM audio signal for driving a loudspeaker, and a horizontal synchronization signal and a vertical synchronization signal for driving respectively horizontal deflection yokes and vertical deflection yokes of said cathode ray tube; and
means to convert the horizontal synchronization signal frequency (Fh) and the vertical synchronization signal frequency (Fv) of a standard TV signal selected from the group consisting of NTSC, PAL and SECAM systems to a higher Fh and a higher Fv to reduce flickering of the picture.

2. The TV receiver as described in claim 1, wherein said Fh and said Fv of the incoming composite signal are multiplied by 3/2 times.

3. The TV receiver as described in claim 2, wherein the Fh is changed from 15.734 kHz to 23.601 kHz and Fv from 59.94 Hz to 89.91 Hz for the NTSC standard; the Fh from 15.625 kHz to 23.4375 kHz and Fv from 50.00 Hz to 75.00 Hz for the PAL (I,B,G,H,D,N) standard; the Fh from 15.734 kHz to 23.601 kHz and Fv from 59.94 Hz to 89.91 Hz for the PAL (M) standard; the Fh from 15.624 kHz to 23.4375 kHz and Fv from 50.00 Hz to 75.00 Hz for the SECAM standard.

4. The TV receiver as described in claim 1, wherein said means comprises:
a decoder to convert said AM video signal in analog form for each picture element (pixel) on a horizontal scan line to digital data;
a first clock for shifting said digital data to a serial memory;
a second clock faster than said clock for reading said digital data stored in said serial memory;
a first counter for counting the number of pixels on a line and for generating a second horizontal sync signal to drive the horizontal yoke
a second counter for counting the number of scan lines in a field and for generating a second vertical sync signal to drive the vertical yoke;
a digital to analog converter for converting the digital data read from said serial memory to analog signals for driving said cathode ray tube; and
clock generators for said first clock and said second clock.

6. The TV receiver as described in claim 5, wherein said clock generators are derived from a frequency synthesizer, comprising a reference crystal, a phase locked loop, and a programmable register to program the frequency of the clock generator.

7. The TV receiver as described I claim 1, further comprising auxiliary circuits for accommodating devices selected from the group consisting a video camera, a VCR, a computer, Set-top box, and DVI connector, where the video signals comply with the TV standards selected from the group consisting of NTSC, PAL and SECAM systems.

8. The TV receiver as described in claim 7, wherein said auxiliary circuits and said means for increasing Fh and Fv are incorporated in a System-on-chip (SOC) integrated circuit.

9. The TV receiver as described in claim 8, wherein said SOC comprises:
(i). MCU I/F (MCUIF) block, which provides the means for the external low cost CPU & its firmware to communicate with the chip for the purposes of setting up configuration registers, enabling the varieties of video streams writing to frame buffer through a memory arbitor, etc, and contains the on screen display control and I2C serial bus;
(ii) 2. Registers from all (REGS) block, which resides in all required blocks, contains the configuration and control registers, may be accessed via the I2C bus using MCU to optimize the physical floor plan and to avoid the routing congestion compared to one central register block;
(iii) Video Input Port (VIP) block, which provides an interface to various digitizers and decoders, as well as a integrated Video Decoder option, including 2 ports of video decoder outputs, digital RGB, YCbCr, YPbPr and the output of DVI receiver, and contains bus width translations for video to frame buffer memory write;
(iv) Video Decoder(CVD) block, which takes external tuner output of composite video signals and generates the digital YUV signals for internal video input port, and prefers to contain the digital 3D comb filter and closed caption stream;
(v) ADC block, which has 2 sets so that IMagic can support the PIP or POP among video input sources, having at least 1 set of high speed ADC to handle one of video decoder and YPbPr/RGB;
(vi) Memory Controller (MIU) block, which provides prioritized access to the frame buffer memory, having memory arbitration done by fixing priority combined with programmable cycle length and refresh cycle provided by internal 512 clocks counter or blanking period;
(vii) OSD Write (OSW) block, which contains the on screen display control data to write into display memory, with the OSD data selected between text-based and bit-mapped(graphics) based and writing the OSD data into memory to allow the stretch/scaling of OSD images;
(viii) GFX Engine block, which provides 64-bit 2D acceleration for graphics, contains the Bit Block, Transfer and line draw engine, executes one operation in every clock cycle, and preserves this block for the usage of Interactive TV and the Electronic Programming Guide scrolling function;
(ix) OSD Control block, which handles memory read accesses for the OSD image, and does the Blinking, Transparency and Blending;
(x) Display/Video FIFO block, which handles memory read accesses for video overlays, containing the video streams for OSD, Picture in Picture(PIP), and Split Screen(POP) with the frame rate conversion and de-interlacing functions requiring the read access to the frame buffer.
(xi) Graphics Pipe block, which contains the Graphics or VGA compatibility logic for the pixel path, includes VGA attribute control, and allows the switch of digital RGB stream overlay with OSD and PIP;
(xii) Palette block, which contains 2 sets of SRAM, one being used for the Gamma control of display output, and the other one used to store the bit-mapped OSD image;
(xiii) Video Pipe block, which performs the video acceleration, control and blending functions, including functions: video window set up for PIP, POP, color space conversion, both X and Y image scaling 4:3, 16:9, panorama, zoom, De-Interlacing, Frame-Rate Conversion, and using Video 1 & Video 2 FIFO to stored current and proceeding line video data for Vertical interpolation.
(xiv) Display Pipeline block, which merges the primary video display, the overlay(s) and the OSD, having the advanced picture processing done at this block including Luminance/Chromance Transience, Gamma Control, Black Level Adjustment, Brightness/Contrast adjustment, white Level fine tune, hue, saturation level, and the overlay pictures blending;
(xv) CRT Control (CRTC) block, which controls the synchronization signals for the displays, as well as overlay and OSD positioning;
(xvi) AUDIO Lip Sync (ALS) block, which contains the synchronization circuit for audio signals to align the pipe line stages required to output video stream;
(xvii) DAC block, which contains the digital analog converters for RGB monitors, running up to 170 Mhz with 3.3v operation;
(xviii) PLL block, which contains the phase lock loops for memory and pixel clock generation,
(xix) Clocks block, which contains the clock enable, MUXes and buffers for the memory, pixel, bus and video port clocks;
(xx) Power Management block which contains control for the various power management features and
(xxi) Test Circuit block, which contains test circuit for both standard cell logic and line buffer/SRAM logic.

10. A method of reducing flickering of a television picture on a television screen for receiving television signals selected from the group of standards consisting of NTSC, PAL and SECAM, comprising the steps of:
converting an incoming television signal into an intermediate frequency (IF) signals;
decoding the video signals of said IF signals into digital data for each pixel on a horizontal line of a television picture;
writing said digital data into a serial memory at a first clock rate;
reading said digital data at a second clock rate higher than said first clock rate;
converting said digital data read from said serial memory into analog signal for display on said television picture; and
retracing each vertical field of said picture after a predetermined number of horizontal lines of said picture to increase the refresh rate of said picture.

11. The method of reducing flickering as described in claim 10, wherein the second clock rate is increased by 3/2 times over that of said first clock rate, and the frame refresh rate is increased.
